(19) United States
(12) Patent Application Publication
(10) Pub. No.: US 2007/0177112 A1
(43) Pub. Date: Aug. 2, 2007

(54) Starry sky display apparatus and furniture combined therewith

(75) Inventor: Ken-ichi Kato, Noda-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: STELLA PRECISION CO., LTD., Noda-shi (JP)

(21) Appl. No.: 11/345,222

(22) Filed: Feb. 2, 2006

(51) Int. Cl. G03B 21/28

(52) U.S. Cl. 353/98

(57) ABSTRACT

A starry sky display apparatus comprises a mirror having a reflecting film, the reflecting film having a plurality of light transmission holes defined therein in a scattered pattern, and a light source unit disposed behind the mirror for emitting light to the mirror. The light emitted by the light source unit passes, through the transmission holes to a front face of the mirror, to produce and display a group of star images. The starry sky display apparatus produces and displays the group of star images in sharp focus with a depth feel in a dark environment and is used as an ordinary mirror in a bright environment.

### BACKGROUND OF THE INVENTION

1. Field of the Invention

The present invention relates to a starry sky display apparatus for producing a group of star images with a depth feel like an actual starry sky in a dark environment, and a piece of furniture combined with such a starry sky display apparatus.

2. Description of the Related Art

There have heretofore been known starry sky display apparatus for producing a group of star images like an actual starry sky in a dark environment. For example, Japanese laid-open patent publication No. 2003-241303 discloses a planetarium for simply projecting celestial images in a wide angle onto a projection surface such as a screen dome, an inner room wall surface or an inner ceiling surface.

The disclosed planetarium has a projector which projects a group of star images onto the projection surface which is spaced a certain distance from the projector. The user or observer sees light reflected from the projection surface.

The projector has a lens for keeping the projected star images into focus as much as possible. However, it is impossible to eliminate all out-of-focus blurs from the projected star images. Particularly, when star images are projected onto an inner wall surface or an inner ceiling surface of a box-shaped room, it is difficult in principle to keep the projected star images in sharp focus because the distances from the projector to the respective star images or the angles of the respective star images with respect to the projector cannot be the same as each other.

Japanese utility model registration No. 3081769 discloses a simple planetarium for reproducing a number of star images using optical fibers. Japanese utility model registration No. 3053620 reveals a wall covering or a ceiling covering which displays celestial bodies with a luminous paint for astronomical study. Japanese laid-open patent publication No. 2002-34745 discloses an ornamental mirror incorporating color photographic images.

The user or observer of the simple planetarium disclosed in Japanese utility model registration No. 3081769 directly sees light. However, the disclosed planetarium is not arranged to display a group of star images with a depth feel. If the disclosed planetarium is to reproduce a more realistic starry sky, then it will need a greater number of optical fibers of more different sizes, and hence will be more complex in structure and more difficult to be manufactured. In addition, it is difficult to construct the disclosed planetarium in a low profile because the optical fibers cannot easily be bent along turns of small radii. Furthermore, it is difficult to reduce the size of the planetarium because the planetarium needs a light unit for supplying light to the bundle of optical fibers.

The wall covering or ceiling covering disclosed in Japanese utility model registration No. 3053620 displays many constellations. However, it does not incorporate measures for displaying the constellations with a depth feel. The planetarium disclosed in Japanese utility model registration No. 3081769 and the wall covering or ceiling covering disclosed in Japanese utility model registration No. 3053620 are used only in a dark environment. These documents (No. 3081769 and No. 3053620) are silent as to how valuable the disclosed devices are when the devices are used in a bright environment.

The ornamental mirror shown in Japanese laid-open patent publication No. 2002-34745 incorporates the color photographic images in a portion of the mirror surface. However, the disclosed ornamental mirror does not produce and display a group of star images.

### SUMMARY OF THE INVENTION

It is an object of the present invention to provide a starry sky display apparatus which is of a simple structure and can produce and display a group of star images in sharp focus with a depth feel in a dark environment and can be used as an ordinary mirror in a bright environment.

To achieve the above object, there is provided in accordance with the present invention a starry sky display apparatus comprising: a mirror having a reflecting film, the reflecting film having a plurality of light transmission holes defined therein in a scattered pattern; and a light source unit disposed behind the mirror for emitting light to the mirror: whereby the light emitted by the light source unit passes, through the transmission holes to a front face of the mirror, to produce and display a group of star images.

The displayed star image group represents a cluster of star images having different brightness and colors as with a real starry sky so that the user directly sees the light emitted from the starry sky display apparatus.

The star image group, which is made up of the star and many other stars on the reflecting surface of the mirror, is visually recognized as real images, and a virtual image of the star and many other virtual images of the other stars are seen behind the star image group of the real images.

Preferably, the displayed star image group represents a cluster of star images corresponding to the light transmission holes, respectively.

Preferably, the light transmission holes are formed in relative positions corresponding to the positions of stars in an actual starry sky, and have respective relative sizes corresponding to the brightness of the stars in the actual starry sky.

Preferably, for use in an ornamental or mentally healing application, the light transmission holes are appropriately designed for array and size to display the stars of the star image group in desired array and brightness.

Preferably, each of the light transmission holes has a diameter ranging from about several tens μm to about 1 mm if the user views the starry sky display apparatus at a close distance ranging from several tens cm to several m.

The light source unit applies the light selectively uniformly and irregularly to the mirror to produce and display the star image group in a unique fashion.

Preferably, the mirror comprises: a transparent mirror base; a reflecting film fixed to a reverse side of the mirror base; a protective film fixed to a reverse side of the reflecting film to cover and protect the reflecting film, the light transmission holes being formed in the protective film in a scattered pattern; and a transparent corrosion prevention film, which is fixed to a reverse side of the protective film and covers the protective film and embeds the light transmission holes.

For example, the mirror comprises a dark mirror having a low reflectance, and the reflecting film of the dark mirror comprises a lead film or a lead-free metal film.

Preferably, the starry sky display apparatus further comprises: a coloring means, disposed between the mirror and the light source unit, for coloring the light which passes through the transmission holes.

Preferably, the coloring means comprises: a transparent plate of glass or synthetic resin; and a plurality of transparent dye patches mounted on the transparent plate; the transparent dye patches being positioned in alignment with the corresponding light transmission holes.

Preferably, the light source unit comprises: a light source for generating the light; and a light diffusion plate, spaced a predetermined distance from the light source, for applying the light substantially uniformly to the mirror.

Preferably, the light source comprises a plurality of light emitters for emitting the light, which is spread at a predetermined angle, to the light diffusion plate over its entire surface or a portion thereof.

For example, the light source unit comprises: a thin planar light-emitting device for generating the light. The thin planar light-emitting device comprises an electroluminescence sheet for emitting substantially uniform planar light from its entire surface and for applying the substantially uniform planar light substantially uniformly to the mirror.

Preferably, the starry sky display apparatus further comprises: a ridge line producing light-blocking plate disposed between the mirror and the light source unit, the ridge line producing light-blocking plate comprising a sheet having a predetermined shape for displaying a mountain ridge line as a silhouette.

Preferably, the starry sky display apparatus is incorporated in a toy, a building, a structure, a mirror house or an educational material.

A piece of furniture incorporates a starry sky display apparatus according to the present invention therein. The starry sky display apparatus comprises: a mirror having a reflecting film, the reflecting film having a plurality of light transmission holes defined therein in a scattered pattern; and a light source unit disposed behind the mirror for emitting light to the mirror: whereby the light emitted by the light source unit passes, through the transmission holes to a front face of the mirror, to produce and display a group of star images; wherein the piece of furniture is selected from a group consisting of a wall-hung mirror, a tabletop mirror, a bathroom mirror, a dresser, a dressing table, a window-shaped mirror and a table.

The starry sky display apparatus constructed as described above is of a simple structure. The starry sky display apparatus can produce and display a group of star images in sharp focus with a depth feel in a dark environment and can also be used as an ordinary mirror in a bright environment.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a perspective view of a wall-hung mirror incorporating a starry sky display apparatus according to an embodiment of the present invention;

FIG. 2 is an exploded perspective view showing a basic structure of the starry sky display apparatus;

FIG. 3 is a fragmentary vertical cross-sectional view of the starry sky display apparatus;

FIG. 4 is a fragmentary vertical cross-sectional view of a starry sky display apparatus according to another embodiment of the present invention;

FIG. 5A is a fragmentary cross-sectional view showing the principles of a process for producing the group of star images with a depth feel;

FIG. 5B is a perspective view showing the principles of the process for producing the group of star images with a depth feel;

FIG. 6 is a perspective view of a bathroom having a bathroom mirror as a piece of furniture incorporating the starry sky display apparatus according to the present invention;

FIG. 7 is a perspective view of a dresser as a piece of furniture incorporating the starry sky display apparatus according to the present invention;

FIG. 8 is a perspective view of a window-shaped mirror as a piece of furniture incorporating the starry sky display apparatus according to the present invention;

FIG. 9 is a perspective view of a table as a piece of furniture incorporating the starry sky display apparatus according to the present invention;

FIG. 10 is a fragmentary front elevational view of a building incorporating the starry sky display apparatus, according to the present invention, having curved and flat surfaces; and

FIG. 11 is a perspective view showing an internal structure of a mirror house which incorporates the starry sky display apparatus according to the present invention.

### DESCRIPTION OF THE PREFERRED EMBODIMENTS

Like or corresponding parts are denoted by like or corresponding reference characters throughout views.

A starry sky display apparatus according to the present invention comprises a mirror, having a reflecting film with a plurality of light transmission holes defined therein in a scattered pattern, and a light source unit disposed behind the mirror for emitting light to the mirror. The light emitted by the light source unit passes through the light transmission holes to a front face of the mirror. When the starry sky display apparatus is in a dark environment, the light passing through the light transmission holes produces and displays a group of star images in sharp focus with a depth feel. When the starry sky display apparatus is used in a bright environment, the starry sky display apparatus functions as an ordinary mirror.

The starry sky display apparatus according to the present invention may be incorporated in any of various articles, e.g., a piece of furniture, which include a mirror as a component. Pieces of furniture which may incorporate the starry sky display apparatus include a wall-hung mirror, a desktop mirror, a bathroom mirror, a dresser, a dressing table, a window-shaped mirror and a table, etc.

The starry sky display apparatus may also be incorporated in any of various small products such as a jewel box with a mirror, any of various toys employing a mirror such as a kaleidoscope, and simple planetariums for use as an educational tool for scientific education, particularly astronomical education.

The starry sky display apparatus may be used as an ornamental object on ceilings, walls and floors of buildings which need to be of highly ornamental nature and also need to have a mentally healing effect and ceiling and walls of elevators. For example, the starry sky display apparatus may be used on walls, ceilings and floors of rooms, corridors, and lobbies of residential houses, hotels, stores and other buildings. The starry sky display apparatus may also be incorporated in mirror houses located in amusement parks and theme parks.

The mirror of the starry sky display apparatus usually has a planar mirror surface. However, it may have a curved mirror surface such as a spherical mirror surface, an elliptical mirror surface and a paraboloidal mirror surface.

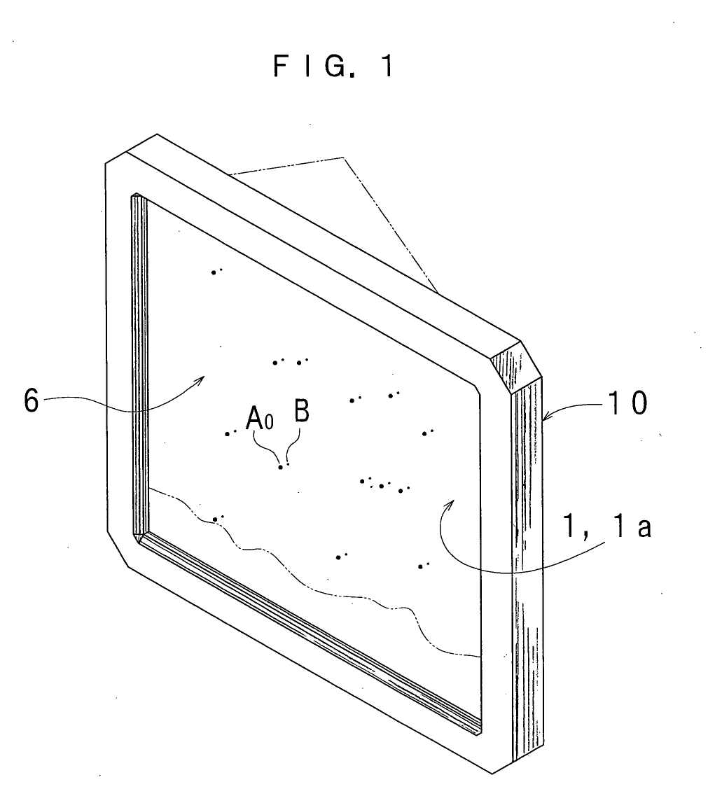

FIGS. 1 through 11 show starry sky display apparatus 1, 1a, 1b, 1c according to various embodiments of the present invention. Each of the starry sky display apparatus 1, 1a, 1b, 1c comprises a mirror 2 having a reflecting film 3 with a plurality of light transmission holes (hereinafter referred to as “transmission holes”) defined therein in a scattered pattern. Of the transmission holes through which light can pass, transmission holes 4, 4a, 4b, for example, will be described below.

The transmission holes 4, 4a, 4b are formed in relative positions corresponding to the positions of stars in an actual starry sky, and have respective relative sizes corresponding to the brightnesses of those stars in the actual starry sky.

A star image group (a group of star images) 6 displays individual stars which make up a constellation such as Orion and other bright fixed stars at brightnesses and sizes which are substantially the same as those of corresponding stars in the actual starry sky. In some of FIGS. 1 through 11, Orion is schematically shown at an approximate location and other constellations are schematically shown at appropriate locations.

Each of the starry sky display apparatus 1, 1a, 1b and 1c comprises a light source unit 5, 5a. The mirror 2 is irradiated with light R emitted by the light source unit 5, 5a disposed behind the mirror 2. The light R passes through the transmission holes 4, 4a, 4b to a front face of the mirror 2, which faces the user, and then produces and displays the star image group 6. The mirror 2 should preferably be irradiated substantially uniformly with the light R. However, the light R may irregularly be applied to the mirror 2 to produce and display the star image group 6 in a unique fashion.

Each of the starry sky display apparatus 1, 1a and 1b can produce and display the star image group 6 in sharp focus with a depth feel in a dark environment, and can be used as an ordinary mirror in a bright environment.

According to the present invention, each of the transmission holes corresponds to one star image to be displayed, and the displayed star image group represents a cluster of star images corresponding to the light transmission holes, respectively. Therefore, each of the starry sky display apparatus is capable of displaying star images in sharper focus with higher contrast than the conventional devices which use photographs and images.

Furthermore, each of the starry sky display apparatus 1, 1a and 1b is of a simpler structure than the conventional planetariums which require dome screens and projectors.

FIG. 1 shows a wall-hung mirror 10 as a piece of furniture incorporating the starry sky display apparatus 1, 1a therein. The wall-hung mirror 10 is usually installed on a wall of a bedroom or a living room of a house, or a wall of a guest room, a corridor or a lobby of a hotel.

In the starry sky display apparatus 1, 1a shown in FIGS. 1 through 5A, 5B, the mirror 2 comprises a transparent mirror base 11 and a reflecting film 3 fixed to the reverse side of the mirror base 11. The mirror 2 also has a light-blocking protective film 12 and a transparent corrosion prevention film 13 joined to the protective film 12. The protective film 12 is fixed to the reverse side of the reflecting film 3 and wholly or partly covers and protects the reflecting film 3. The transmission holes 4, 4a, 4b are formed in the protective film 12 in a scattered pattern.

The mirror base 11 is made of glass or synthetic resin, e.g., acrylic resin, and is capable of transmitting light therethrough. If the starry sky display apparatus is required to have higher mechanical strength, then the mirror base 11 should preferably be made of tempered glass. If the starry sky display apparatus is required to be light in weight, then the mirror base 11 should preferably be made of synthetic resin such as acrylic resin or the like.

The reflecting film 3 comprises a thin metal film securely deposited on the mirror base 11 by coating, sputtering, evaporation or the like. Generally, the reflecting film 3 is primarily made of silver. However, the reflecting film 3 may be made of aluminum, copper, lead, gold or any of various other materials.

If a lead film or a lead-free metal film is used as the reflecting film 3, then a mirror of low reflectance with such a film is referred to as “dark mirror” as the reflecting film 3 is dark in color, making the mirror look posh and ornamental. The dark mirror is not limited by the material and reflectance of its reflecting surface.

If the mirror 2 comprises the dark mirror, then it looks highly posh and ornamental. The starry sky display apparatus 1, 1a incorporating the dark mirror is effective when is used to table and ceiling materials.

The protective film 12 is made of a light-blocking material. The protective film 12 has a rust prevention capability and a moisture prevention capability, and is capable of preventing the reflecting film 3 of metal from being corroded.

The corrosion prevention film 13 is fixed to the reverse side of the protective film 12. The corrosion prevention film 13 wholly or partly covers the protective film 12, and embeds the transmission holes 4, 4a and 4b. The corrosion prevention film 13 is made of a transparent resin or paint, e.g., silicon varnish, and is capable of transmitting light therethrough.

The corrosion prevention film 13 embeds the transmission holes 4, 4a, 4b which extend through the reflecting film 3 and the protective film 12. Therefore, the corrosion prevention film 13 holds the reflecting film 3 and the protective film 12 out of direct contact with the atmosphere at the transmission holes 4, 4a, 4b, thereby preventing the reflecting film 3 and the protective film 12 from being corroded.

A plurality of transmission holes including the transmission holes 4, 4a and 4b are formed in the reflecting film 3 and the protective film 12. The transmission holes can easily be formed in the reflecting film 3 and the protective film 12 on the reverse side of the mirror 2 by drilling, etching or laser-beam machining based on a fixed star coordinate data which is commercially available.

To form the transmission holes, portions of the reflecting film 3 and the protective film 12 are removed. In the regions from which the reflecting film 3 and the protective film 12 are removed, i.e., in the formed transmission holes, the reflecting film 3 and the protective film 12 are exposed and would tend to be corroded by humidity or the like. The regions, from which the reflecting film 3 and the protective film 12 are removed, are coated with a highly transparent, colorless, humidity-resistant paint, thereby forming the corrosion prevention film 13 to prevent the reflecting film 3 and the protective film 12 from being corroded.

The diameters of the transmission holes 4, 4a and 4b are determined by the magnitudes of corresponding stars. For example, a transmission hole corresponding to a brighter star has a larger diameter, and a transmission hole corresponding to a darker star has a smaller diameter. Though the transmission holes 4, 4a, 4b should preferably be circular in shape, they may be of any of various other shapes including an elliptical shape, a triangular shape, a quadrangular shape, a polygonal shape and a star shape, etc.

The starry sky display apparatus 1, 1a, 1b, 1c may need to be viewed by the user at a close distance or a far distance. To meet such needs, the diameters of the transmission holes 4, 4a and 4b may be reduced or increased though their relative size relationship remains unchanged.

For example, if the user views the starry sky display apparatus 1, 1a, 1b, 1c at a close distance ranging from several tens cm (centimeter) to several m (meter), then the diameters of the transmission holes 4, 4a, 4b should be in the range from about several tens μm (micrometer) to about 1 mm (millimeter).

If the user views the starry sky display apparatus 1, 1a, 1b, 1c at a greater distance, then the diameters of the transmission holes 4, 4a, 4b should be increased to allow a greater amount of light to be emitted from the transmission holes 4, 4a, 4b.

If only a representative constellation, e.g., Orion, is to be displayed with greater emphasis depending on the use of the mirror 2, then only the diameters of the transmission holes 4, 4a, 4b which display the constellation may be increased. In this case, the transmission holes 4, 4a, 4b should preferably be circular in shape, but may be of any of various other shapes including an elliptical shape, a triangular shape, a quadrangular shape, a polygonal shape and a star shape, etc.

The fixed star coordinate data are released from the Internet homepage of an astronomical organization or commercially available as recorded data on recording mediums such as a CD-ROM or the like. Therefore, the accurate positions, brightness levels, and spectral (color) information of desired stars can easily be reproduced from the fixed star coordinate data without the need for starry sky photographs. The star image group 6 reproduced and based on the fixed star coordinate data can be used not only for a mentally healing effect and an ornamental effect, but also as an educational tool for scientific education, particularly astronomical education.

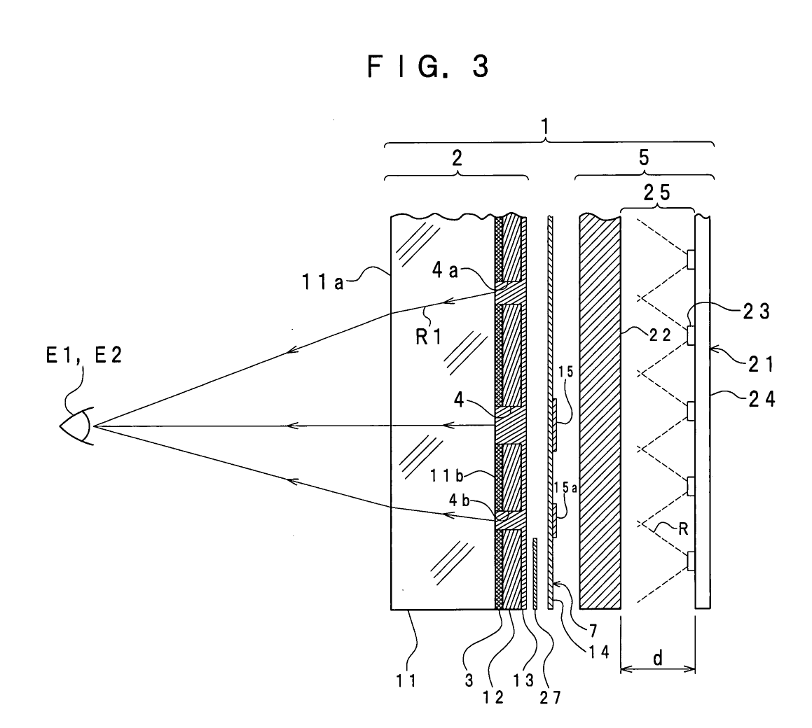

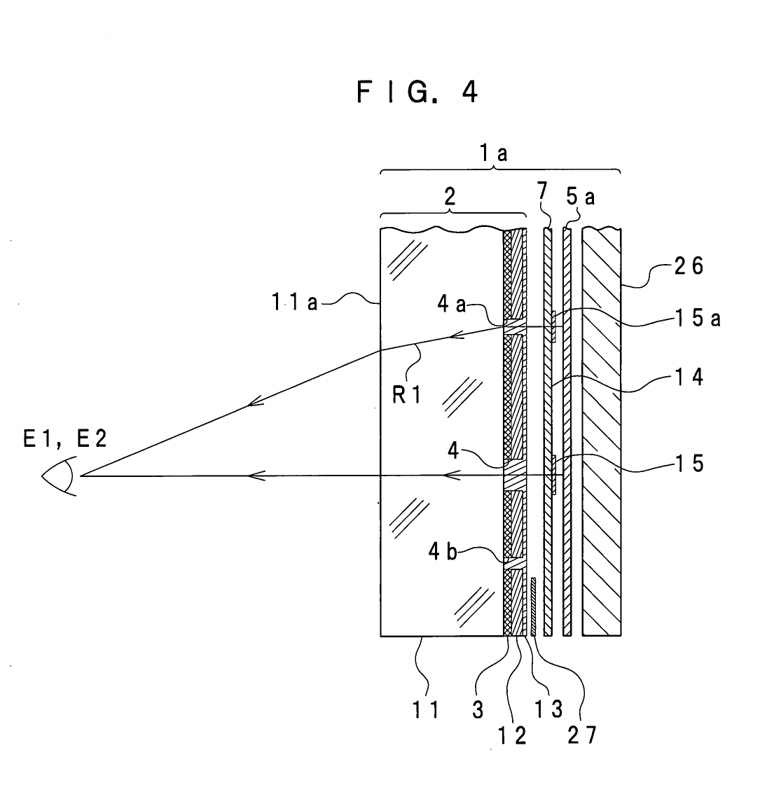

A coloring means 7 is disposed between the mirror 2 and the light source unit 5, 5a positioned behind the mirror 2. The coloring means 7 colors the light which passes through the transmission holes 4, 4a and 4b. Specifically, in the starry sky display apparatus 1 shown in FIG. 3, the coloring means 7 colors the light which passes through the transmission holes 4, 4b. In the starry sky display apparatus la shown in FIG. 4, the coloring means 7 colors the light which passes through the transmission holes 4, 4a. In this manner, the light which passes through the transmission holes is colored to produce the colored star images, making the star image group 6 look realistic.

The coloring means 7 comprises a transparent plate 14 of glass or synthetic resin and a plurality of transparent dye patches 15, 15a mounted on the transparent plate 14. The dye patches 15, 15a are positioned in alignment with the corresponding transmission holes. The dye patches 15, 15a comprise transparent coatings of transparent color ink in red, blue and yellow, for example, which are applied to a surface of the transparent plate 14.

To color only the light which passes through the transmission holes 4, 4a, 4b, the dye patches 15, 15a are slightly larger in size than the transmission holes 4, 4a, 4b, and are positioned in alignment with the corresponding transmission holes 4, 4a, 4b. Therefore, white light emitted by the light source unit 5, 5a does not enter the transmission holes 4, 4a and 4b.

If the light source unit 5, 5a emits white light, then the coloring means 7 may comprise a color filter which is colored partly or wholly. The coloring means 7 may be formed in the shape of a disk, for example, having differently colored segments, and the disk may be rotated to change the colors of the star image group 6.

In as much as the coloring means may be positioned between the mirror 2 and the light source unit 5, 5a, the coloring means may be printed on the reverse side of the mirror 2. The coloring means may be arranged to color only the light which produces a representative star or constellation.

If the starry sky display apparatus 1, 1a are to be simplified in structure or employ a light source unit for emitting light other than white light for ornamental purposes, then the coloring means 7 may be dispensed with.

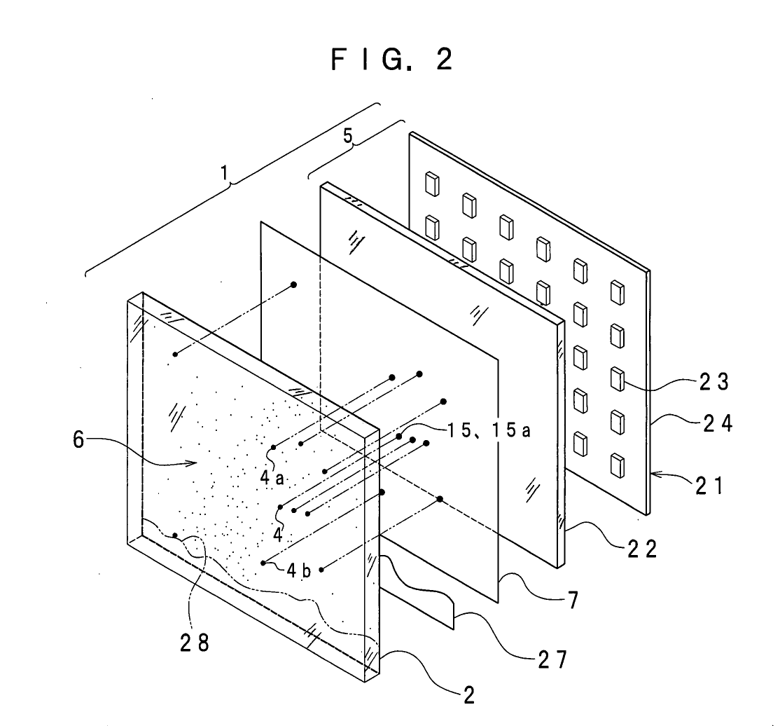

The light source unit 5 of the starry sky display apparatus 1 shown in FIGS. 2 and 3 comprises a light source 21 for generating light R and a light diffusion plate 22. The light diffusion plate 22 is spaced from the light source 21 by a predetermined distance d, and applies substantially uniform light to the mirror 2. A gap 25 extending over the distance d is provided between the light source 21 and the light diffusion plate 22.

The light source 21 has a plurality of light emitters 23 for emitting the light R. The light R emitted by the light emitters 23 is applied to the light diffusion plate 22 over its entire surface or a portion thereof. Each of the light emitters 23 should preferably comprise a light-emitting diode (LED), a fluorescent lamp or a cold-cathode tube as it emits white light. If the starry sky display apparatus 1 is used for ornamental purposes, then the light source 21 may comprise the light emitters for emitting light other than white light.

The light R emitted by the light emitters 23 is spread at a predetermined angle by the gap 25, and is then applied to the light diffusion plate 22 over its entire surface or a portion thereof. Since the light source 21 has a plurality of light emitters 23, the light R is applied substantially uniformly to the light diffusion plate 22 over its entire surface or a portion thereof

The light emitters 23 are arranged in horizontal rows and vertical columns according to a regular pattern on a planar wiring board 24 having electric current wires. If the light emitters 23 comprise light-emitting diodes, then they emit white light.

The light-emitting diodes tend to suffer light emission variations. Therefore, they should be used in combination with current regulative diodes (CRDs) or LED driver ICs for supplying uniform currents to cause the light-emitting diodes to emit light of constant luminance.

The light diffusion plate 22 performs a function as a diffuser for receiving the light R from the light source 21, diffusing the light R therein, and thereafter applying substantially uniform light through the coloring agent 7 to the mirror 2. The light diffusion plate 22 comprises an opalescent and transparent synthetic resin plate. However, the light diffusion plate 22 may comprise a frosted glass plate.

The light source unit 5 has the light diffusion plate 22, and the gap 25 is provided between the light source 21 and the light diffusion plate 22. Accordingly, the light source unit 5 is capable of converting the light R emitted by the light source 21 toward the mirror 2 into substantially uniform planar light.

In the starry sky display apparatus la shown in FIG. 4, the light source unit 5a comprises a thin planar light-emitting device for generating the light R. The thin planar light-emitting device comprises an EL (Electroluminescence) sheet. The EL sheet is insulated as specified by the EL sheet manufacturer. The EL sheet should preferably be a white-light EL sheet for emitting white light. The light source unit 5a is held by a holder plate 26 disposed behind the light source unit 5a.

The light source unit 5a which comprises a thin planar light-emitting device is capable of emitting substantially uniform planar light from its entire surface. The emitted substantially uniform planar light is applied substantially uniformly to the mirror 2 through the coloring means 7.

The starry sky display apparatus la does not require the gap 25 and the light diffusion plate 22 which are provided in the light source unit 5 of the starry sky display apparatus 1 shown in FIGS. 2 and 3. The sheet-like light source unit 5a can be directly held in intimate contact with the sheet-like coloring means 7. As a result, the starry sky display apparatus la is thin as a whole and is made up of a reduced number of parts.

Each of the starry sky display apparatus 1, la shown in FIGS. 1 through 8 has a ridge line producing light-blocking plate (hereinafter referred to as “light-blocking plate”) 27 disposed between the mirror 2 and the light source unit 5, 5a. The light-blocking plate 27 comprises a sheet having a predetermined shape for displaying a mountain ridge line 28 as a silhouette. In FIGS. 2 through 4, the light-blocking plate 27 is shown as being sandwiched between the mirror 2 and the coloring means 7. However, the light-blocking plate 27 may be sandwiched between the coloring means 7 and the light source unit 5, 5a.

The light-blocking plate 27 displays the mountain ridge line 28 as a silhouette for creating a large-scale feel and a realistic feel in combination with star images produced by the starry sky display apparatus.

In the starry sky display apparatus 1 shown in FIGS. 2 and 3, the light-blocking plate 27, the coloring means 7 and the light diffusion plate 22 are successively stacked on the reverse side of the mirror 2. The mirror 2, the light-blocking plate 27, the coloring means 7 and the light diffusion plate 22 are integrally closely held together as a multilayer structure. However, the mirror 2, the light-blocking plate 27, the coloring means 7 and the light diffusion plate 22 are shown separately in FIGS. 2 and 3 before they are combined together.

In the starry sky display apparatus la shown in FIG. 4, the light-blocking plate 27, the coloring means 7, the light source unit 5a and the holder plate 26 are successively stacked on the reverse side of the mirror 2. The mirror 2, the light-blocking plate 27, the coloring means 7, the light source unit 5a and the holder plate 26 are integrally closely held together as a multilayer structure. In FIG. 4, the mirror 2, the light-blocking plate 27, the coloring means 7, the light source unit 5a and the holder plate 26 are shown separately before they are combined together.

Since the starry sky display apparatus la is free of the light diffusion plate 22 and the gap 25 shown in FIG. 3, the starry sky display apparatus 1a is relatively thin as a whole. Therefore, when the starry sky display apparatus 1a is used as a wall-hung mirror, a bathroom mirror, a window-shaped mirror or the like, it has a short depth, i.e., a small thickness.

Each of the starry sky display apparatus 1, 1a thus assembled is of such a structure that no unwanted light leaks out of the light source unit 5, 5a. Each of the starry sky display apparatus 1, 1a needs to be of a water-resistant structure if it is to be used in bathrooms or outdoors.

As shown in FIGS. 1 through 4, light, e.g., white light, produced by the light source unit 5, 6a passes through the coloring means 7 and falls on the reverse side of the mirror 2, i.e., the reverse side of the corrosion prevention film 13. The light as it passes through the transparent plate 14 of the coloring means 7 remains to be white light. When the light passes through the dye patches 15, 15a on the transparent plate 14, the light is colored in red, blue and yellow by the dye patches 15, 15a. When the light reaches the light-blocking plate 27, the light is blocked by the light-blocking plate 27.

Most of the light which is applied to the corrosion prevention film 13 is blocked by the light-blocking protective film 12. The transmission holes 4, 4a, 4b are free of the reflecting film 3 and the protective film 12, but are filled with the transparent corrosion prevention film 13. Therefore, the light applied to the transmission holes 4, 4a, 4b passes through the transmission holes 4, 4a, 4b, and then passes through the mirror base 11, and then leaves a face side 11a of the mirror base 11 and finally travels through the ambient air to the left and right eyes E1, E2 of the user.

As described above, the light emitted by the light source unit 5, 5a travels straight through or is refracted by the rear and front surfaces of the coloring means 7, the rear and front surfaces of the corrosion prevention film 13, and the rear and front surfaces of the mirror base 11, and then reaches the left and right eyes E1, E2 of the user. The user can thus directly see the light which emerges from the face side of the mirror 2 of the starry sky display apparatus 1, 1a.

The star image group 6 produced and displayed by the starry sky display apparatus 1, 1a represents a cluster of star images having different brightnesses and colors as with a real starry sky. The user directly sees the light emitted from the starry sky display apparatus 1, 1a. Therefore, the star image group 6 is represented as a cluster of star images which are kept in sharp focus.

When the user sees fixed stars in a real starry sky, the user directly sees the light emitted from those fixed stars. Each of the starry sky display apparatus 1, 1a also allows the user to directly see the light emitted therefrom. Consequently, the user sees the star images in sharp focus just like the real fixed stars, as the star images are not represented by reflected light.

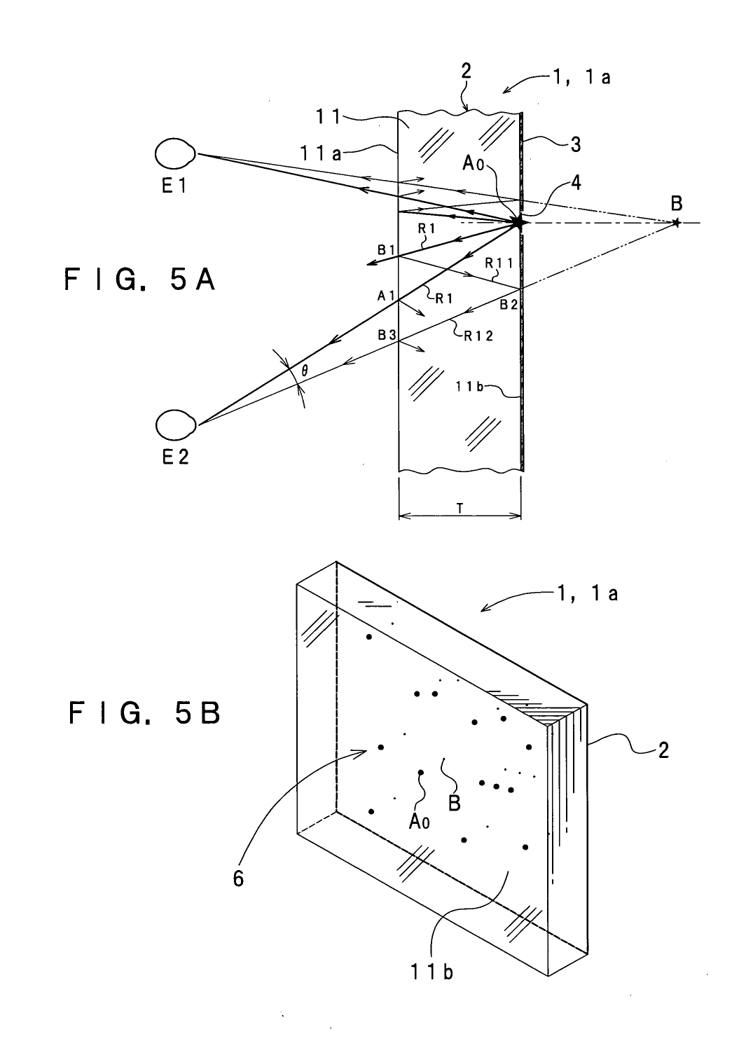

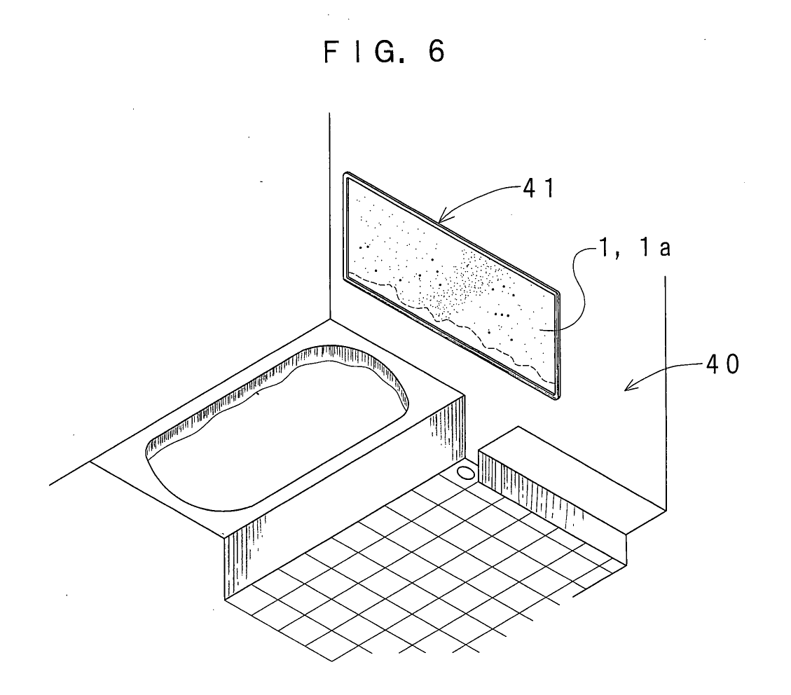

The principles by which the star image group 6 is formed with a depth feel will be described below with reference to FIGS. 6A and 5B.

The mirror base 11 has a different refractive index if it is made of a different material such as glass, acrylic resin or the like. According to the present invention, a virtual image B of a star A0 is slightly seen behind the star A0 to give the user a depth feel with respect to the displayed star. A change, caused in the way the star image is seen due to a different refractive index based on the type of the material of the mirror base 11, does not pose a functional problem. Therefore, a change in the path of light due to such a different refractive index is omitted from illustration in FIG. 5A.

A star image produced by light having passed through the transmission hole 4 will be described by way of example with reference to FIG. 5A. Light (direct light) R1 passing through the transmission hole 4 in the mirror 2 to the face side of the mirror 2 is partly reflected back into the mirror 2 at a point A1 on the face side 11a of the mirror 2.

Most of the light R1 coming from the transmission hole 4 is refracted at the point A1, and goes out of the mirror 2 from the face side 11a, and reaches the right eye E2 of the user. A bright star image, which is visually recognized by the right eye E2 based on the light R1 which has reached the right eye E2, is referred to as “star A0”. Since the light R1 directly emitted by the star A0 reaches the right eye E2, the right eye E2 sees the star A0 as a real image.

Light is emitted in all directions in the mirror 2 from the transmission hole 4. Most of the light, which has reached a point B1 on the face side 11a of the mirror 2, is refracted at the point B1 and goes out of the mirror 2 from the face side 11a, as with the light from the point A1. Inasmuch as the light from the point B1 is oriented in a direction different from the right eye E2 and the left eye E1, the user does not visually recognize this light in reality.

Weak light R11, which is partly reflected back into the mirror 2 at the point B1, travels toward a point B2 on a reflecting surface 11b on the reverse side of the mirror 2. Light R12, which is fully reflected by the reflecting surface 11b at the point B2, travels toward a point B3 on the face side 11a of the mirror 2. The light R12 reaches the point B3 and is partly reflected into the mirror 2 at the point B3 and attenuated.

Weak light, which remains unreflected at the point B3, is refracted at the point B3 and reaches the right eye E2. As a result, a virtual image B of the star A0 is formed behind the star A0, and is visually recognized as a dark (weak) star image by the right eye E2.

The light path of the light R1, which is emitted from the transmission hole 4, reaches the right eye E2 and is visually recognized as the star A0 by the right eye E2. The light path of the light R1, which is emitted from the transmission hole 4, travels as the light R11 and the light R12 to the right eye E2 and is visually recognized as the virtual image B by the right eye E2. These light paths will be compared with each other.

The light R1 from the star A0 travels from the point A0 to the point A1 to the right eye E2. The light R1, which forms the virtual image B, travels from the point A0 to the point B1 and to the point B2 and to the point B3 finally to the right eye E2. Therefore, the right eye E2 sees the virtual image B farther than the star A0 by the difference between these two different light path lengths. The difference between the different light path lengths increases as the mirror base 11 has a greater thickness T.

In this manner, the user slightly sees the virtual image B of the star A0 behind the star A0. The user sees the virtual image B not on the reflecting surface 11b, but at a point B on an extension behind the reflecting surface 11b. Though the right eye E2 actually sees the light R1 which is emitted from the reflecting surface 11b, since the right eye E2 sees both the bright star A0 and the dark virtual image B, the user visually recognizes the star image with a depth feel. The principles described above also apply to the left eye E1.

FIG. 5B shows the star image group 6, which is made up of the star A0 and many other stars on the reflecting surface 11b of the mirror 2 and is visually recognized as real images. FIG. 5B also shows a virtual image B of the star A0 and many other virtual images of the other stars, and shows that the virtual image B and the other virtual images are seen behind the star image group 6 of the real images.

When the human being as the user visually recognizes an object in a space with a depth, the brain synthesizes the angle formed between the object and the eyes (the right eye E2 and the left eye E1) and an image of the object. When the human being sees the star A0 and the virtual image B thereof simultaneously with the right and left eyes E2, E1, the human being visually recognizes the star A0 as a star image with a depth feel.

The virtual image B is represented by the light which has been reflected a plurality of times in the mirror 2 and which has been weakened at the point B3. As a result, the brightness of the virtual image B is much smaller than the brightness of the star A0.

The angle θ between the light R1 which is applied from the star A0 directly to the eye, e.g., the right eye E2, and the light R12 which represents the virtual image B is very small except when the user sees the mirror 2 at a close range. As a result, the user is not essentially aware of the presence of the virtual image B, and unconsciously has a depth feel only. For example, the starry sky display apparatus is capable of realistically reproducing the Milky Way, which is made of a huge number of stars, by expressing dark stars with a depth feel being effectively given to the starry sky.

Therefore, the starry sky display apparatus is capable of easily creating the star image group 6 with a depth feel. Even if the user is in a small room, the user can be relaxed by looking at a realistic starry sky and can feel as if staying in a wide space.

As described above with reference to FIGS. 1 through 5A, 5B, the starry sky display apparatus 1, 1a can easily produce and display the star image group 6 in sharp focus with a depth feel in a dark environment without the need for a conventional planetarium which displays stars with reflected light. In a bright environment, the starry sky display apparatus 1, 1a can be used as an ordinary mirror.

According to the present invention, specifically, the starry sky display apparatus allows the user to directly see light emitted from the transmission holes 4, 4a, 4b which are positioned on the reflecting surface 11b of the mirror 2, rather than projecting star image group onto a screen as with the conventional planetarium.

Therefore, the starry sky display apparatus according to the present invention allows the user to see the star image group 6 in sharper focus than the planetarium which displays stars with reflected light. Furthermore, the star image group 6 is darkly reflected by the reflecting surface 11b of the mirror 2.

The reflected star image group is represented as a virtual image. The distance, that the light representing the reflected star image group travels until it reaches the right and left eyes E2, E1, is longer than the distance that the light representing the original star, i.e., the star A0, travels, because the light is reflected within the mirror 2. Therefore, the user is placed under such an illusion that the virtual image is positioned behind the original star, and the user has a depth feel with respect to the original star.

Since the star image group 6 is partly reflected by an inner surface (critical angle surface) of the face side 11a of the mirror 2, the intensity of the light R1 is greatly attenuated. The user unconsciously sees the weakly reflected star image group as the virtual image B at a slightly spaced distance, from the original star, which tends to remain unnoticed unless consciously viewed.

Therefore, when the user sees the star image group 6, the user can have a depth feel which provides a realistic feel as if looking at the real starry sky. The starry sky display apparatus is thus capable of sufficiently providing an ornamental effect and a mentally healing effect.

The starry sky display apparatus 1, 1a may be installed in a relatively small room. In such a small room, the starry sky display apparatus 1, 1a can easily produce and display the star image group 6 in sharp focus realistically with a depth feel.

If the user recognizes the star image group 6 only with no concern over the surroundings, then an ornamental effect and a mentally healing effect are sufficiently provided. This is the same as the phenomenon that when a viewer sees a television program or a movie, the viewer recognizes the image only with no concern over the surroundings, resulting in its own self-consciousness trapped in the image.

According to the present invention, furthermore, it is not necessary to display star image groups all over the walls of a room, unlike the conventional planetarium. The starry sky display apparatus according to the present invention allows the user to observe a displayed starry sky for a mentally healing effect in a highly limited space or area, e.g., a portion of a wall of a room, a tabletop or a wall of a bathroom.

The starry sky display apparatus 1, 1a are simpler and thinner than the conventional planetarium and are practical as they can be used as an ordinary mirror in a bright environment. The starry sky display apparatus 1, 1a may be positioned in place of a mirror which has been used, and do not need any new installation space.

The dye patches 15, 15a for producing colors similar to actual star colors are disposed in the positions of transmission holes corresponding to representative bright stars for thereby making the star image group 6 more realistic.

If the starry sky display apparatus is combined with a circuit for increasing and reducing the electric current supplied to the light source unit 5, 5a, then it is possible to reproduce the twinkle of stars which is caused by atmospheric conditions, for thereby making the star image group 6 more realistic.

Various pieces of furniture which incorporate the starry sky display apparatus 1, 1a according to the present invention will be described below. FIGS. 6, 7, 8 and 9 show a bathroom mirror 41, a dresser 42, a window-shaped mirror 43 and a table 44, respectively, and each incorporates the starry sky display apparatus according to the present invention.

As shown in FIG. 6, the bathroom mirror 41 is hung on a wall of a bathroom 40. Since the bathroom 40 is filled with a lot of steam when in use, the conventional planetarium, if used therein, would be unable to project images onto a wall of the bathroom 40 because the projected light would be irregularly reflected by the steam. In addition, the projecting optical system, which has lenses, of the conventional planetarium would fail to operate properly due to water droplets applied thereto, and it would be difficult to make the conventional planetarium fully water-resistant in view of its mechanism.

According to the bathroom mirror 41, however, light emitted by the light source unit 5, 5a disposed behind the mirror is applied to the mirror, and the user directly sees the light which emerges from the face side of the mirror. Consequently, even in the presence of the steam in the bathroom 40, the bathroom mirror 41 produces and displays the star image group in sharp focus with a depth feel.

Therefore, the user in the bathroom 40 with the bathroom mirror 41 can be relaxed by seeing a realistic star image group in sharp focus with a depth feel.

The starry sky display apparatus 1, 1a incorporated in the bathroom mirror 41 should preferably be of a water-resistant structure for protecting itself from moisture, and the surface of the mirror 2 should preferably be frost-resistant to prevent water droplets from being applied thereto.

A switch may be provided near the bathroom mirror 41 for turning on and off the electric light of the bathroom 40 and the power supply of the bathroom mirror 41.

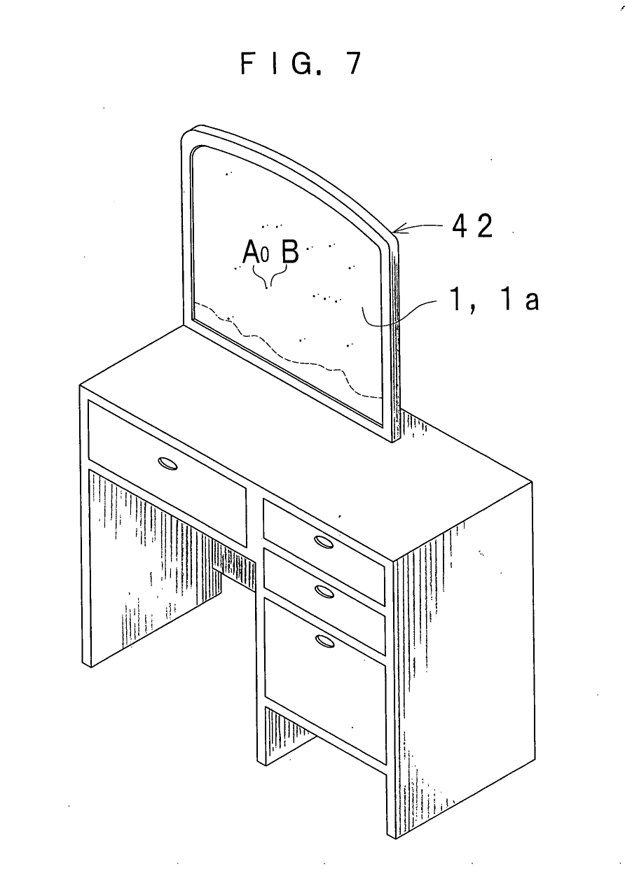

The dresser 42, the window-shaped mirror 43 and the table 44, which are shown respectively in FIGS. 7 through 9, incorporate the starry sky display apparatus 1, 1a therein. The dresser 42, the window-shaped mirror 43 and the table 44 can produce and display a group of star images in sharp focus with a depth feel in a dark environment and can be used as an ordinary mirror in a bright environment.

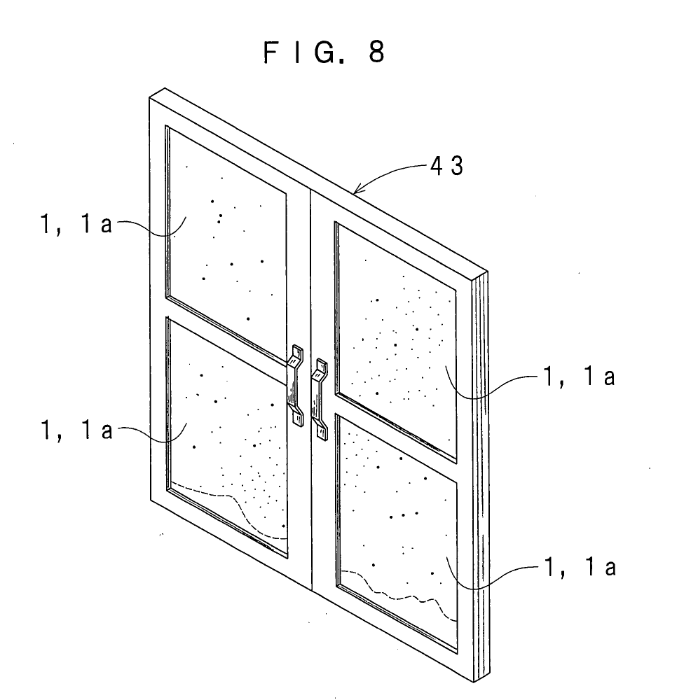

The window-shaped mirror 43 shown in FIG. 8 is a mirror referred to as a dummy mirror which is similar in shape to a window. The window-shaped mirror 43 has a plurality of frame-divided areas each incorporating one of the starry sky display apparatus 1, 1a. If a plurality of (four in FIG. 8) starry sky display apparatus 1, 1a are combined as shown in FIG. 8, the starry sky display apparatus 1, 1a can be applied to a large piece of furniture or any of various large objects.

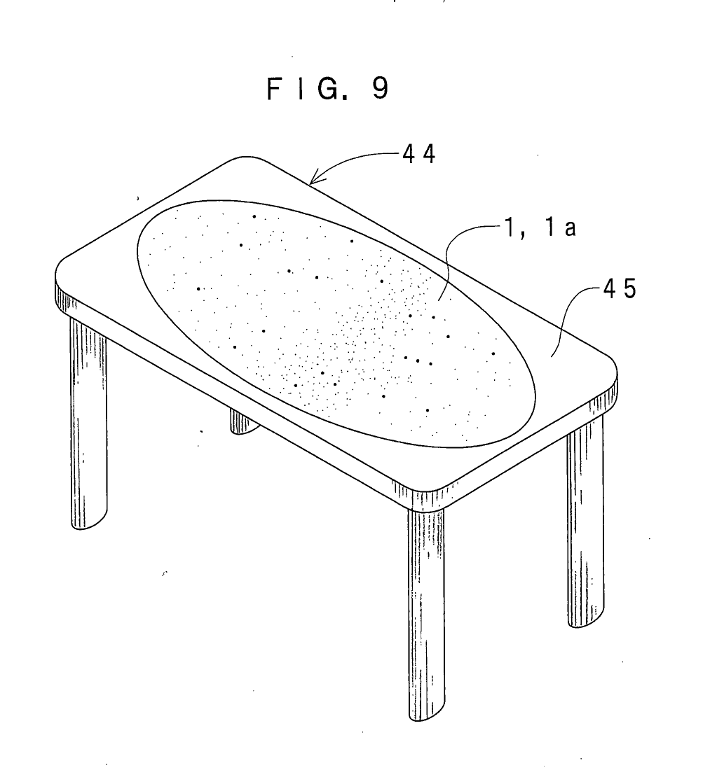

In FIG. 9, the starry sky display apparatus 1, 1a is incorporated in a top panel 45 of the table 44. Each of the starry sky display apparatus 1, 1a shown in FIG. 9 may include the dark mirror for making it look posh and ornamental. If each of the starry sky display apparatus 1, 1a is incorporated in the top panel of a bar counter, then the bar counter looks posh and ornamental.

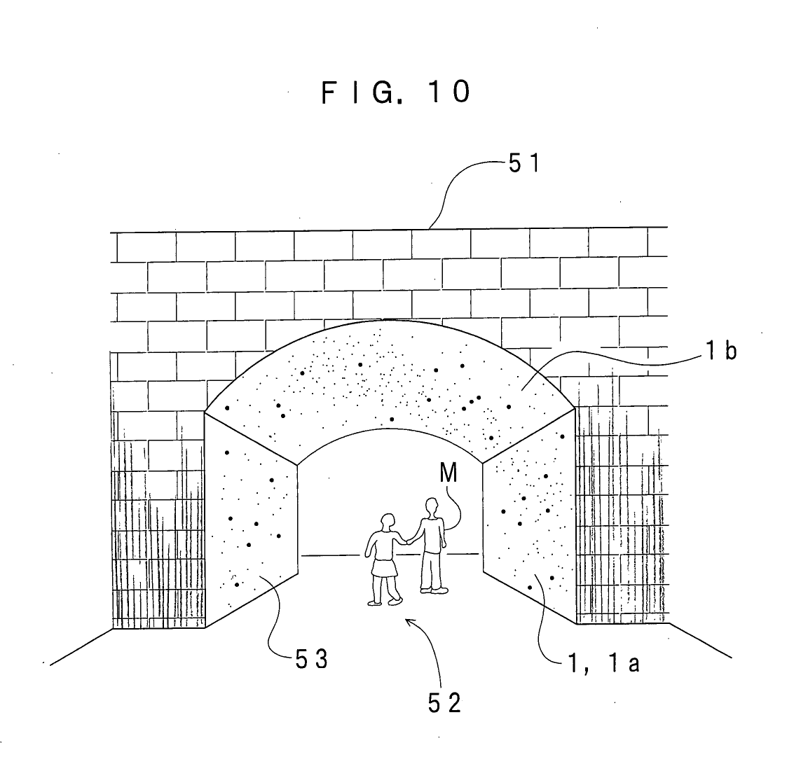

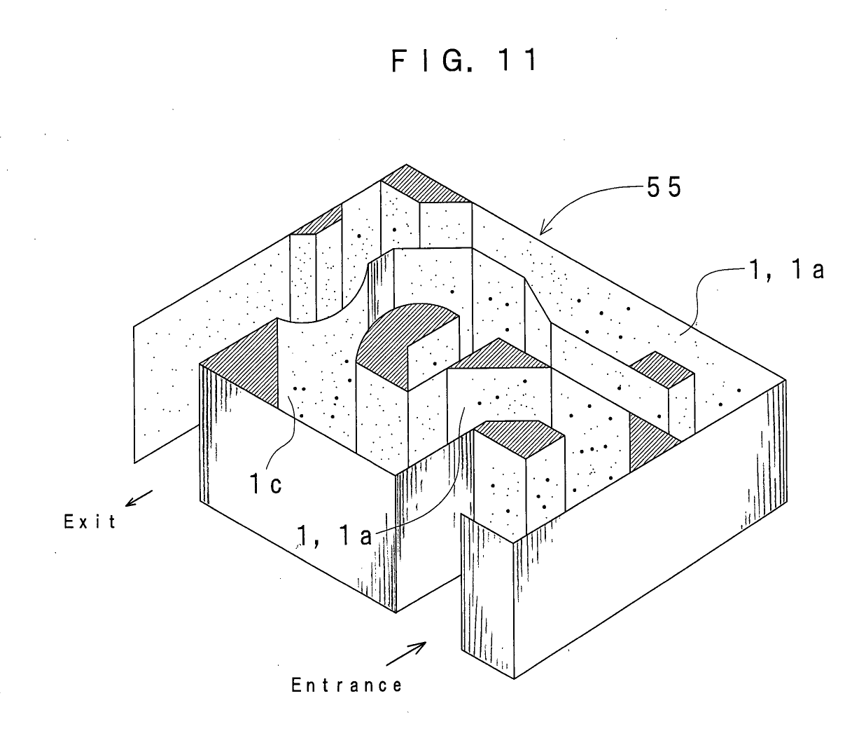

FIG. 10 shows in front elevation a building 51 incorporating the starry sky display apparatus 1, 1a, 1b according to the present invention in curved and flat surfaces. FIG. 11 shows in perspective an internal structure of a mirror house 55 which incorporates the starry sky display apparatus 1, 1a, 1c according to the present invention.

In FIGS. 10 and 11, the starry sky display apparatus 1b, 1c are of a curved shape, i.e., partly cylindrical, in its entirety, and have an internal structure identical to the starry sky display apparatus 1, 1a. The starry sky display apparatus 1b has its face side concave, and the starry sky display apparatus 1c has its face side convex.

In the building 51 shown in FIG. 10, the partly cylindrical starry sky display apparatus 1b is disposed in a partly cylindrical ceiling over a passage 52, and one of the flat starry sky display apparatus 1, 1a is disposed in a flat side surface of the passage 52. An ordinary mirror 53 is disposed in another flat side surface of the passage 52 which faces the flat starry sky display apparatus 1, 1a.

When the starry sky display apparatus 1b in the curved ceiling and one of the starry sky display apparatus 1, 1a in the flat side surface produce and display the star image groups 6, the displayed star image group 6 is reflected by the ordinary mirror 53. When the users M in the passage 52 see the displayed and reflected star image group 6, the users M experience a strange feel as if surrounded by a starry sky.

Depending on the manner in which light is emitted from the starry sky display apparatus 1b in the curved ceiling, the opposite side surfaces of passage 52 may incorporate respective ordinary mirrors 53 for reflecting the star image group 6 displayed by the starry sky display apparatus 1b. With this modification, the flat starry sky display apparatus 1, 1a may be dispensed with.

The mirror house 55 shown in FIG. 11 has a plurality of mirrors disposed as walls in a labyrinth of passages extending from an entrance to an exit. The mirror house 55 may be installed in an amusement park or the like. In the mirror house 55, all the mirrors do not need to incorporate the starry sky display apparatus according to the present invention, but only some of the mirrors may incorporate the starry sky display apparatus according to the present invention. For example, certain flat walls incorporate the flat starry sky display apparatus 1, 1a , and certain curved walls incorporate the curved starry sky display apparatus 1c.

When the labyrinth of passages is bright, all the mirrors of the mirror house 55 operate as ordinary mirrors. When the labyrinth of passages is dark, the user does not see its own reflected image on the walls incorporating the starry sky display apparatus 1, 1a, 1c, but see the star image group displayed by the starry sky display apparatus 1, 1a, 1c. Since the displayed star image group is reflected by other mirrors, the user can see the star image group continuously as the user walks through the labyrinth. Therefore, the user in the labyrinth experiences a strange feel as if wandering in a wide space of universe.

The curved starry sky display apparatus 1c disposed as a curved mirror in the labyrinth introduces a change in the reflection of a star image group, forming a stranger space for greater entertainment. The curved starry sky display apparatus 1c may be replaced with a flat starry sky display apparatus or an ordinary mirror.

The starry sky display apparatus 1, 1a, 1b, 1c according to the present invention may not be used as an educational tool for scientific education, but may be limited to ornamental or mentally healing use. In such limited use, the transmission holes 4, 4a, 4b are appropriately designed for array and size, and, if necessary, are colored to display the stars of the star image group 6 in desired array, brightness and colors. For example, the stars of the star image group 6 may not necessarily be arrayed in the same manner as with actual celestial bodies, but a representative constellation or the Milky Way may appropriately be designed and arrayed for use as the star image group 6.

Small ones of the transmission holes 4, 4a and 4b are formed wholly or partly in the mirror 2. When the starry sky display apparatus 1, 1a, 1b, 1c are in a dark environment, it emits faint light from its entire mirror surface, and hence functions as a bed light.

When the starry sky display apparatus 1, 1a, 1b, 1c are in a bright environment, some large transmission holes 4, 4a and 4b may be visible, but most other small transmission holes 4, 4a, 4b are almost invisible. Even if the transmission holes 4, 4a, 4b are of a visible size, when the starry sky display apparatus 1, 1a, 1b, 1c are used as an ordinary light in a bright environment, the eyes of the user are focused on the user's face or body reflected by the mirror.

Therefore, since the eyes of the user are not focused on the small transmission holes 4, 4a, 4b formed in the reflecting surface 11b of the mirror 2, the user does not see the small transmission holes 4, 4a, 4b unless efforts are made to visually recognize them consciously. Therefore, the starry sky display apparatus 1, 1a, 1b, 1c can be used as an ordinary mirror when used in a bright environment.

The starry sky display apparatus according to the present invention may be incorporated in toys, buildings, structures, mirror houses and educational materials, etc., in addition to various pieces of furniture including wall-hung mirrors.

Although certain preferred embodiments of the present invention have been shown and described in detail, it should be understood that various changes and modifications may be made therein without departing from the scope of the appended claims.

Incidentally, the same reference numerals in the drawings are used to indicate the same or similar components or members.

What is claimed is:

1. A starry sky display apparatus comprising:
a mirror having a reflecting film, said reflecting film having a plurality of light transmission holes defined therein in a scattered pattern; and
a light source unit disposed behind said mirror for emitting light to said mirror:
whereby the light emitted by said light source unit passes, through said transmission holes to a front face of the mirror, to produce and display a group of star images.

2. A starry sky display apparatus according to claim 1, wherein the displayed star image group represents a cluster of star images having different brightness and colors as with a real starry sky so that the user directly sees the light emitted from said starry sky display apparatus.

3. A starry sky display apparatus according to claim 1,
wherein the star image group, which is made up of the star and many other stars on said reflecting surface of the mirror, is visually recognized as real images, and
a virtual image of the star and many other virtual images of the other stars are seen behind the star image group of the real images.

4. A starry sky display apparatus according to claim 1, wherein the displayed star image group represents a cluster of star images corresponding to said light transmission holes, respectively.

5. A starry sky display apparatus according to claim 1, wherein said light transmission holes are formed in relative positions corresponding to the positions of stars in an actual starry sky, and have respective relative sizes corresponding to the brightnesses of the stars in the actual starry sky.

6. A starry sky display apparatus according to claim 1, for use in an ornamental or mentally healing application, wherein said light transmission holes are appropriately designed for array and size to display the stars of the star image group in desired array and brightness.

7. A starry sky display apparatus according to claim 1, wherein each of said light transmission holes has a diameter ranging from about several tens μm to about 1 mm if the user views the starry sky display apparatus at a close distance ranging from several tens cm to several m.

8. A starry sky display apparatus according to claim 1, wherein said light source unit applies the light selectively uniformly and irregularly to said mirror to produce and display said star image group in a unique fashion.

9. A starry sky display apparatus according to claim 1, wherein said mirror comprises:
a transparent mirror base;
a reflecting film fixed to a reverse side of said mirror base;
a protective film fixed to a reverse side of said reflecting film to cover and protect said reflecting film, said light transmission holes being formed in said protective film in a scattered pattern; and
a transparent corrosion prevention film, fixed to a reverse side of said protective film, for covering said protective film and for embedding said light transmission holes.

10. A starry sky display apparatus according to claim 9, wherein said mirror comprises a dark mirror having a low reflectance, and said reflecting film of said dark mirror comprises a lead film or a lead-free metal film.

11. A starry sky display apparatus according to claim 1, further comprising:
a coloring means, disposed between said mirror and said light source unit, for coloring the light which passes through said transmission holes.

12. A starry sky display apparatus according to claim 11, wherein said coloring means comprises:
a transparent plate of glass or synthetic resin; and
a plurality of transparent dye patches mounted on said transparent plate, said transparent dye patches being positioned in alignment with said corresponding light transmission holes.

13. A starry sky display apparatus according to claim 1, wherein said light source unit comprises:
a light source for generating said light; and
a light diffusion plate, spaced a predetermined distance from said light source, for applying said light substantially uniformly to said mirror.

14. A starry sky display apparatus according to claim 13, wherein said light source comprises a plurality of light emitters for emitting said light, which is spread at a predetermined angle, to said light diffusion plate over its entire surface or a portion thereof.

15. A starry sky display apparatus according to claim 1, wherein said light source unit comprises: a thin planar light-emitting device for generating said light.

16. A starry sky display apparatus according to claim 15, wherein said thin planar light-emitting device comprises an electroluminescence sheet for emitting substantially uniform planar light from its entire surface and for applying the substantially uniform planar light substantially uniformly to said mirror.

17. A starry sky display apparatus according to claim 1, further comprising:
a ridge line producing light-blocking plate disposed between said mirror and said light source unit, said ridge line producing light-blocking plate comprising a sheet having a predetermined shape for displaying a mountain ridge line as a silhouette.

18. A starry sky display apparatus according to claim 1, wherein said starry sky display apparatus is incorporated in a toy, a building, a structure, a mirror house or an educational material.

19. A piece of furniture incorporating a starry sky display apparatus therein, said starry sky display apparatus comprising:
a mirror having a reflecting film, said reflecting film having a plurality of light transmission holes defined therein in a scattered pattern; and
a light source unit disposed behind said mirror for emitting light to said mirror:
whereby the light emitted by said light source unit passes, through said transmission holes to a front face of the mirror, to produce and display a group of star images;
wherein said piece of furniture is selected from a group consisting of a wall-hung mirror, a tabletop mirror, a bathroom mirror, a dresser, a dressing table, a window-shaped mirror and a table.
